(19) United States
(12) Patent Application Publication
(10) Pub. No.: US 2011/0082823 A1
(43) Pub. Date: Apr. 7, 2011

(54) Thought Dynamo Decision Mapping Model

(76) Inventor: Ralph Colwell Ennis, Raleigh, NC (US)

(21) Appl. No.: 12/572,315

(22) Filed: Oct. 2, 2009

(51) Int. Cl. G06F 15/18

(52) U.S. Cl. 706/19; 706/15; 706/21

(57) ABSTRACT

The Thought Dynamo Decision (TDD) Mapping Model includes three overlapping 3-D grids that represent decisions from the perspectives of intellect, emotions and imagined outcomes. The continuums of the logic of intellect are power-powerless, good-evil and accuracy-intuitive. The logic of emotion has three continuums: trust-fear, honor-shame, freedom-bonding. And the imagined outcomes continuums are thriving-surviving, desired identity-undesired identity, and meaningful-meaningless. The intersection of each grid forms a central tendency: creative harmony of jealous space. A five step process is used for mapping thoughts and decisions: plot, associate, adjust, solidify and employ. The dynamics of thought and decision are mapped by assigning weights to inputs, strength to associations, dynamically accounting for adjustments and solidifications over time and projecting rules of thumb in decision making onto (3) 3-D axes. This model accounts for decision differences across cultures as illustrated by an examination of the Japanese construct of “amae”.

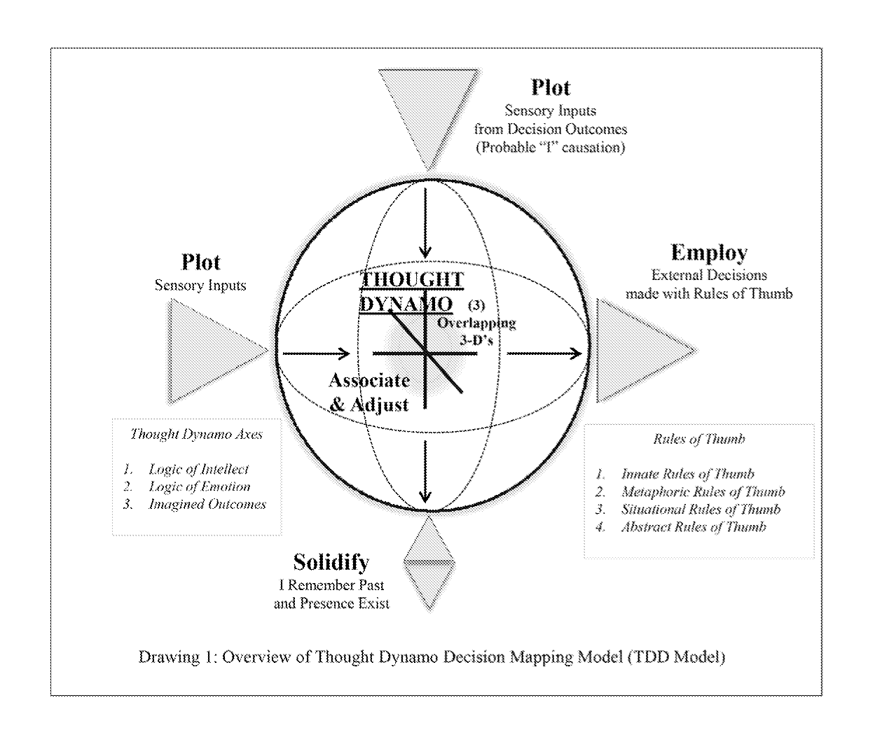

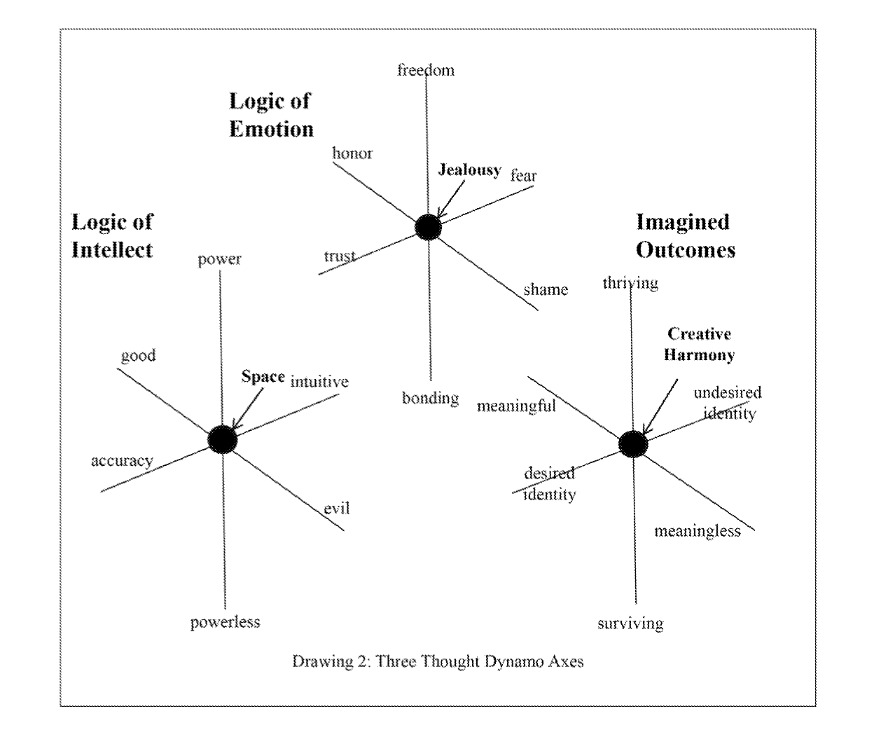

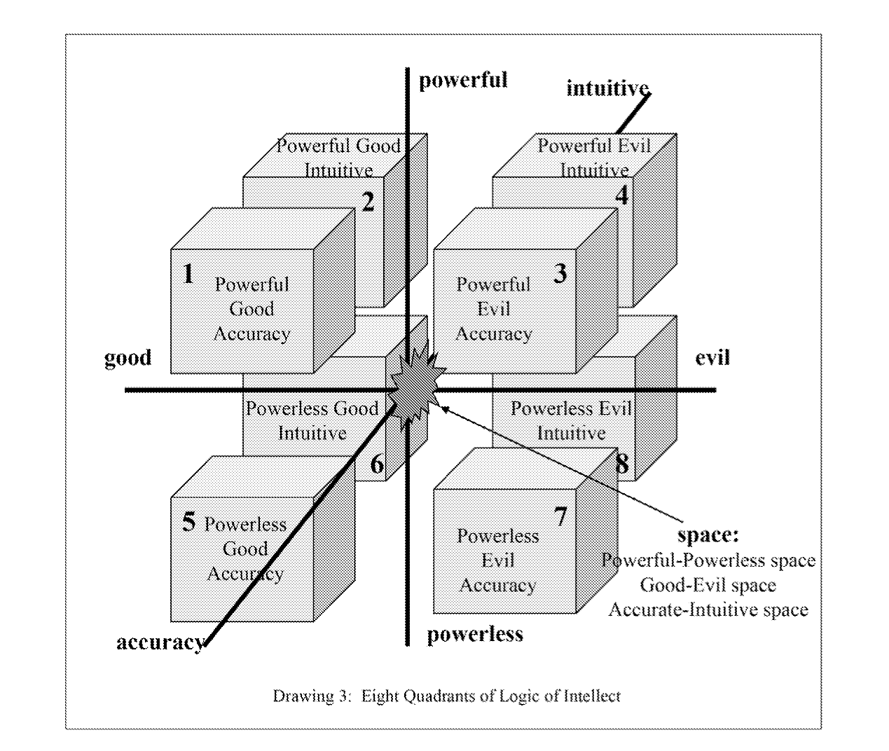

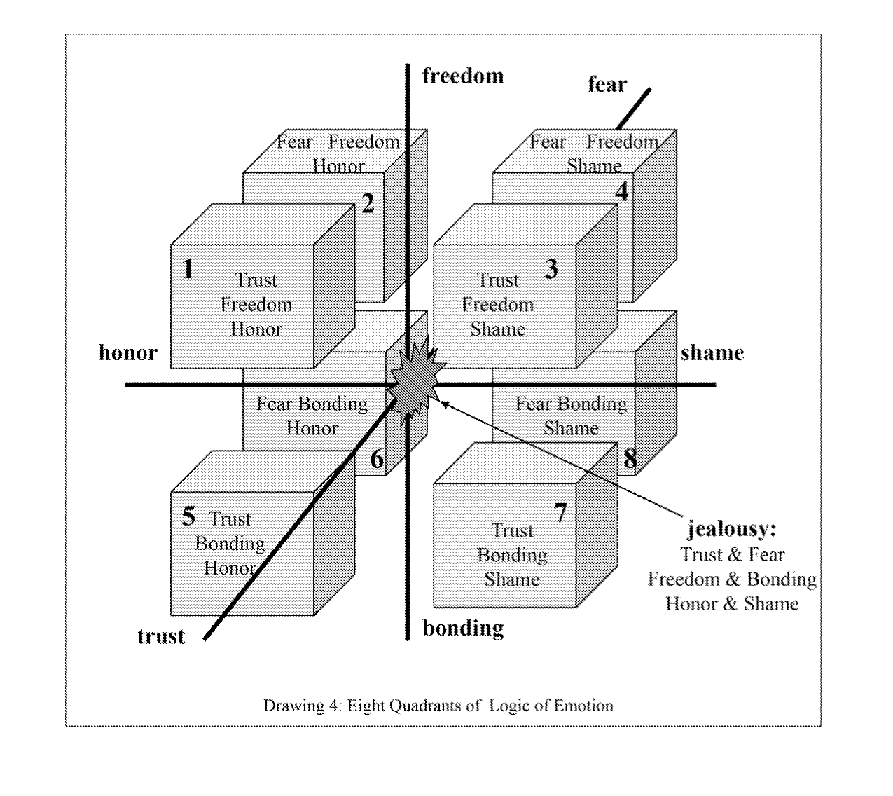

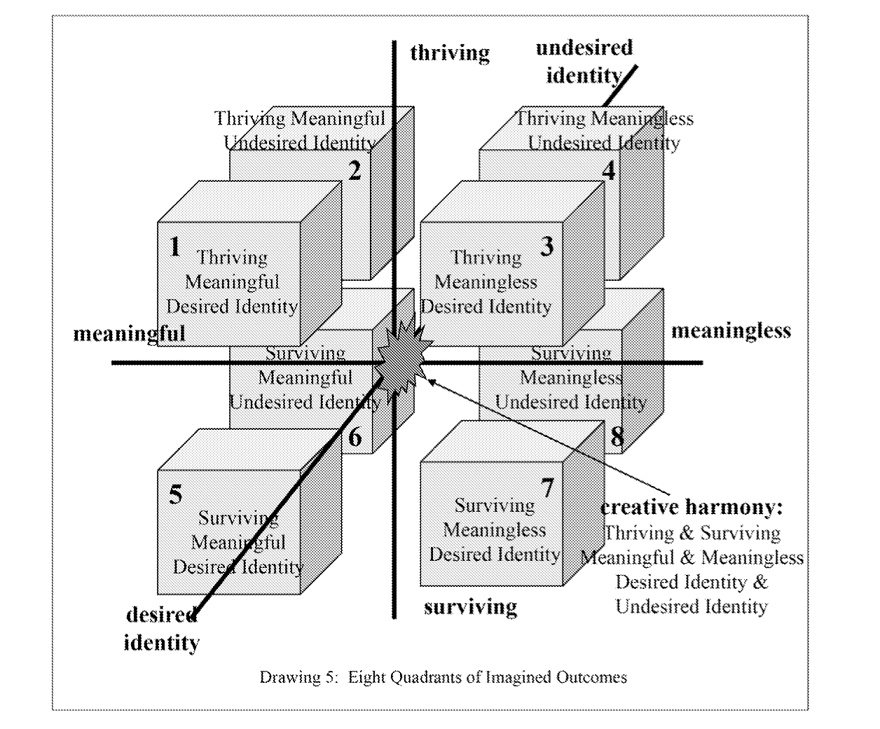

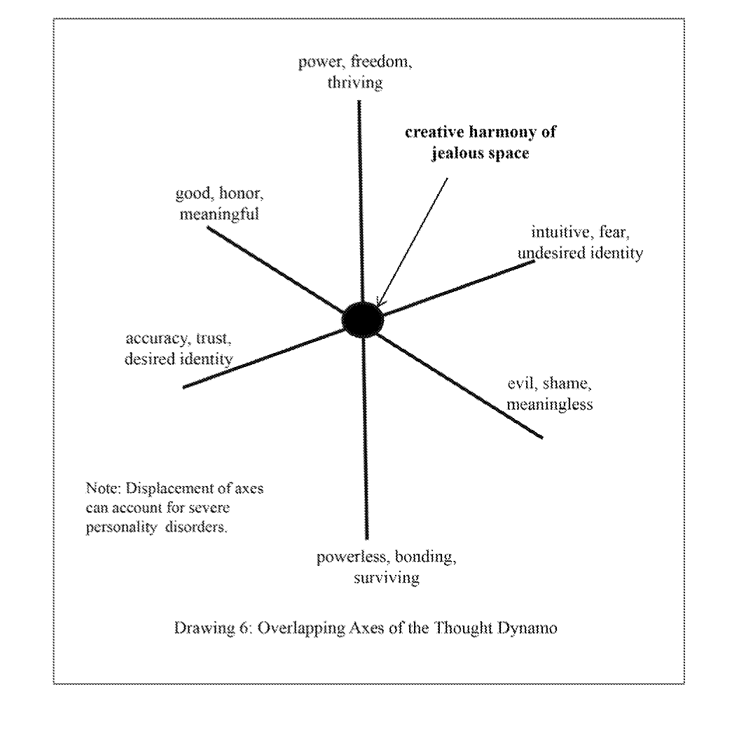

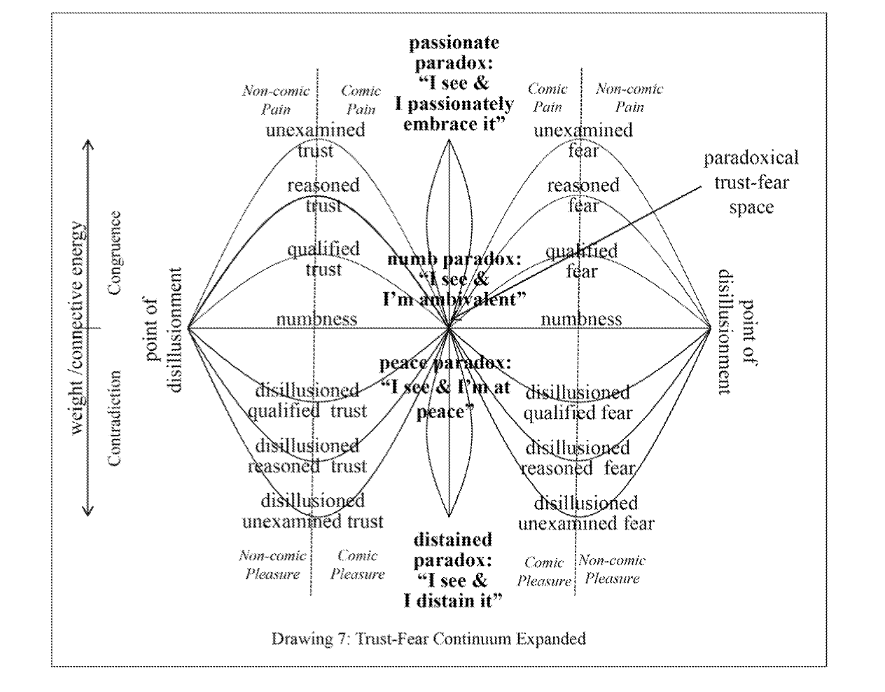

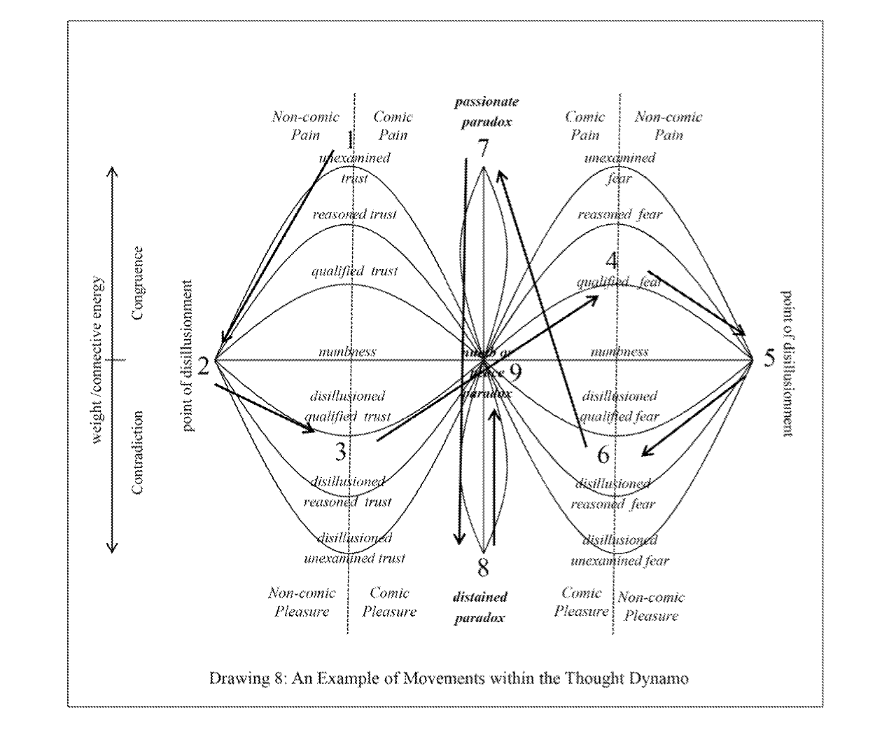

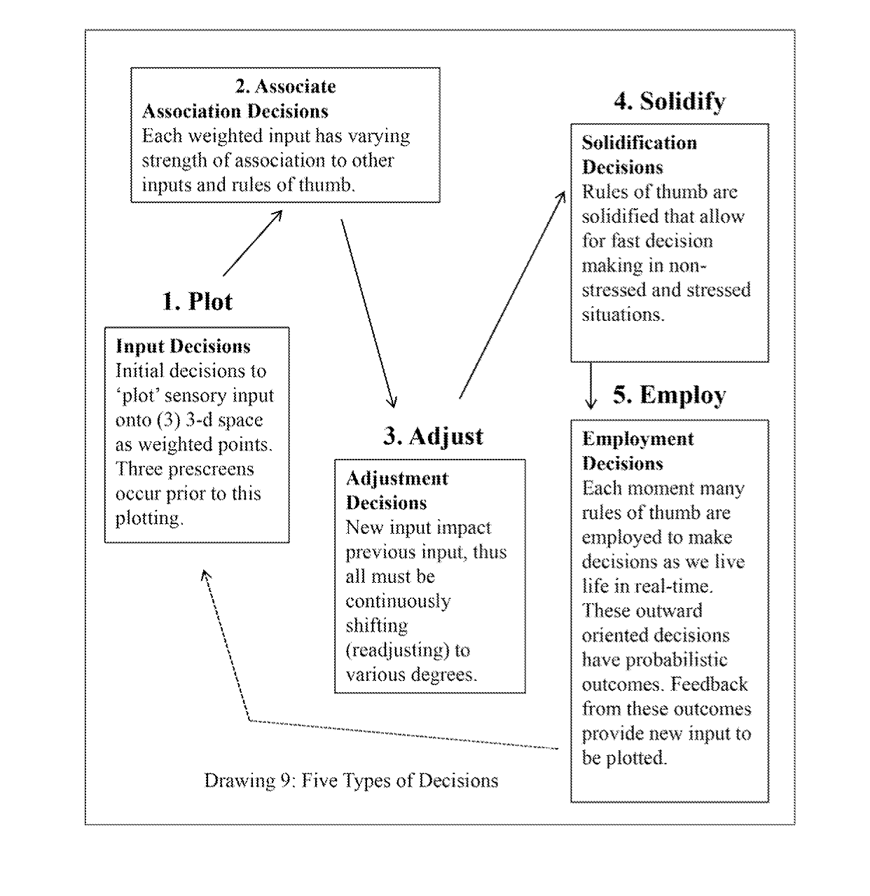

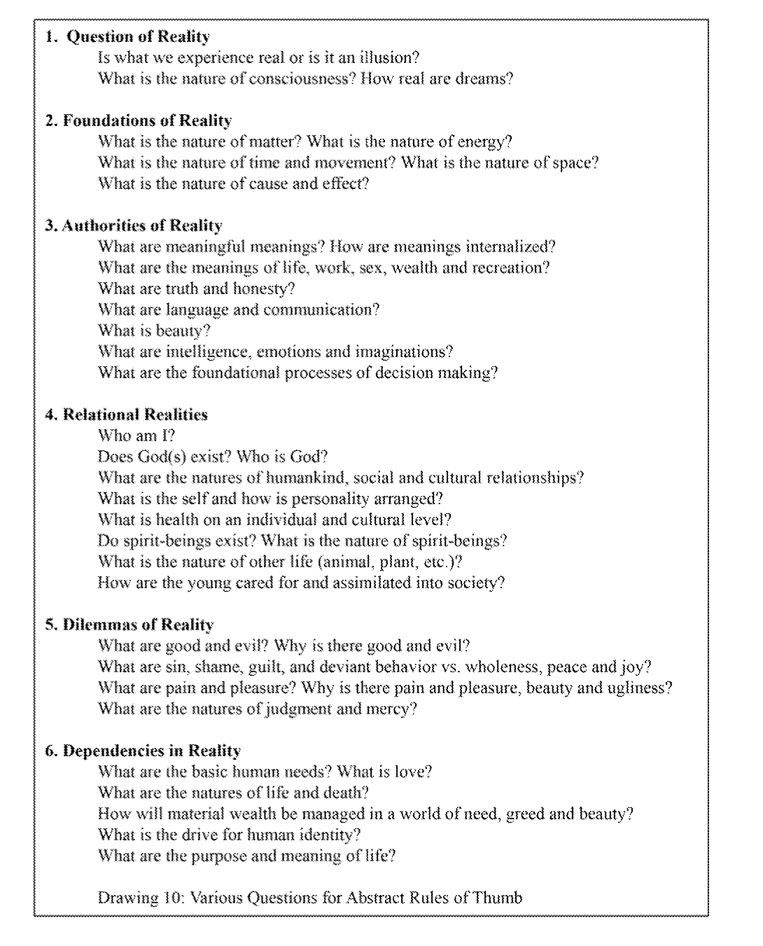

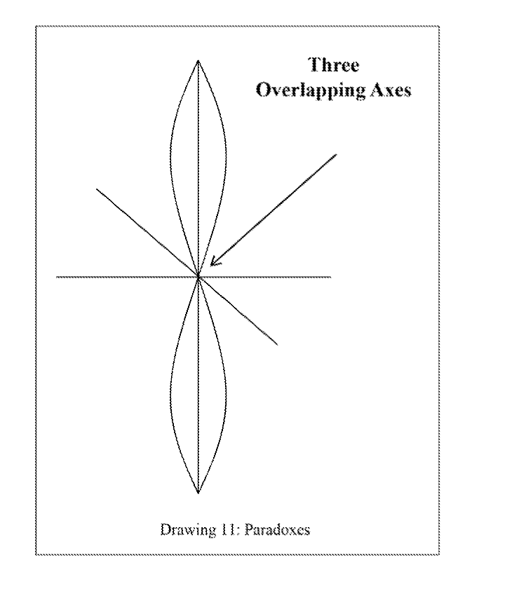

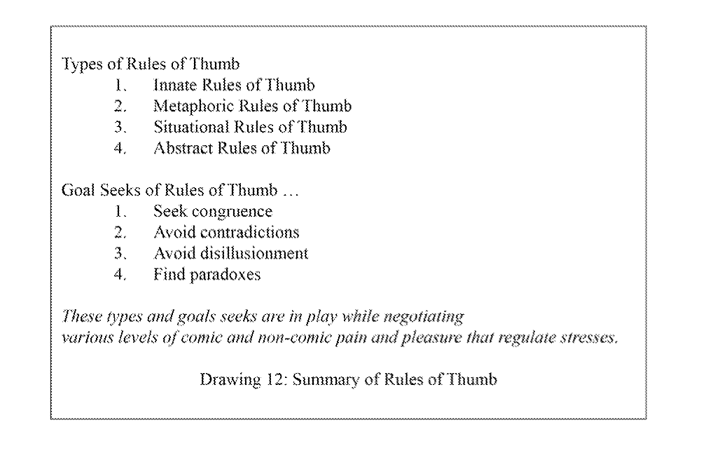

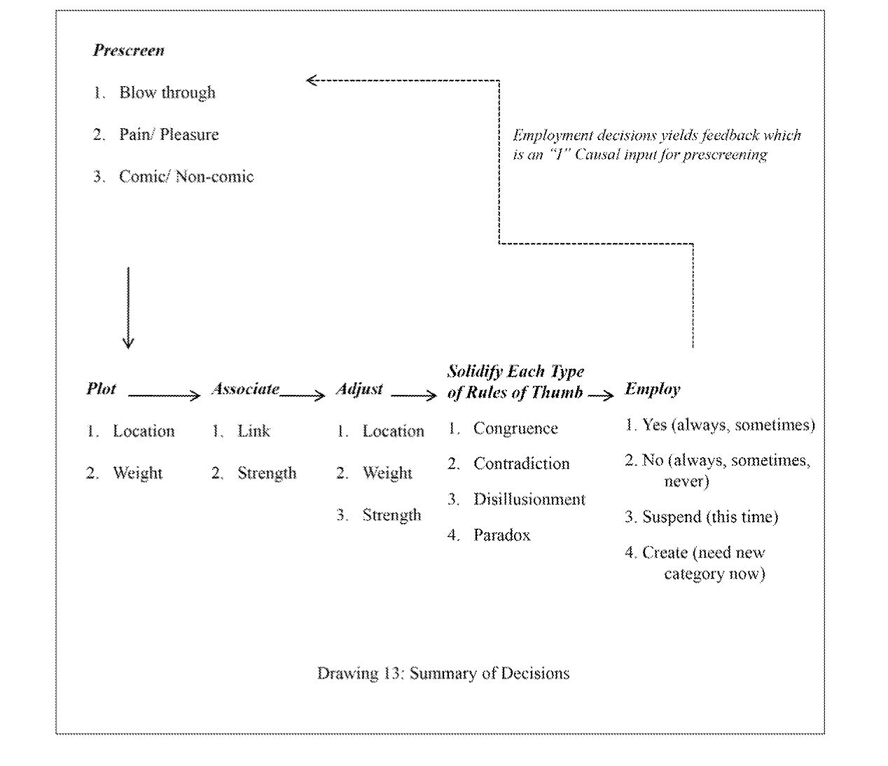

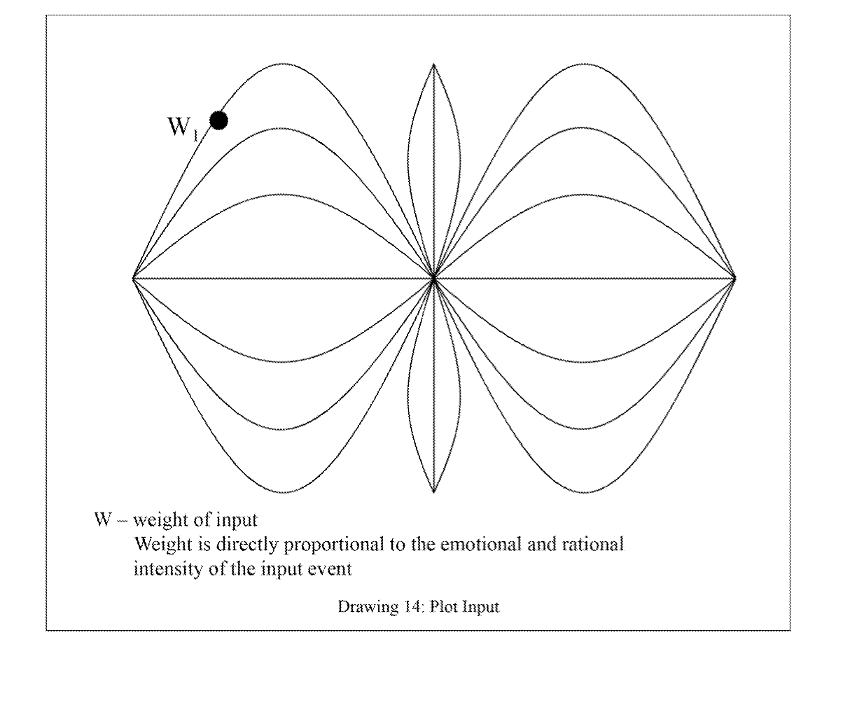

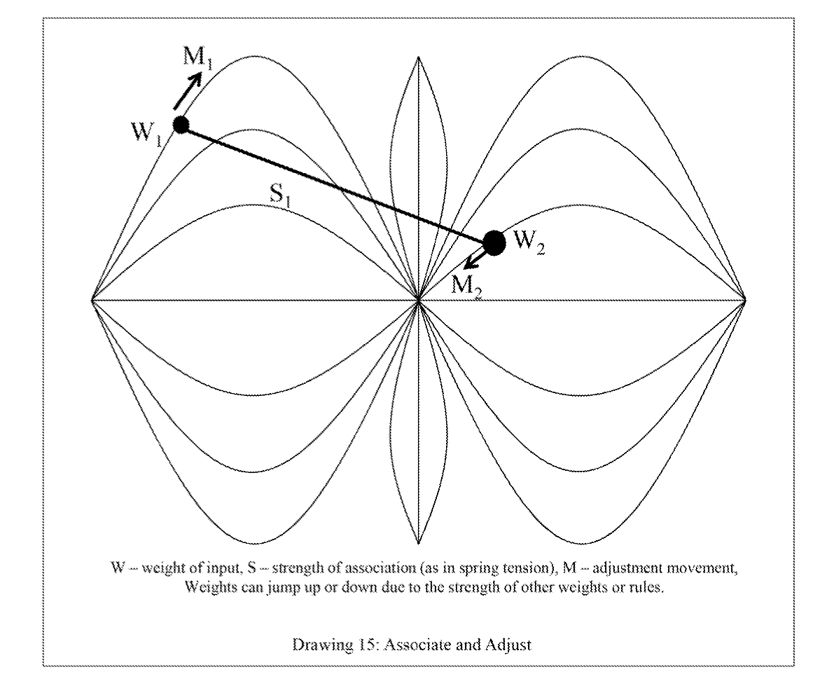

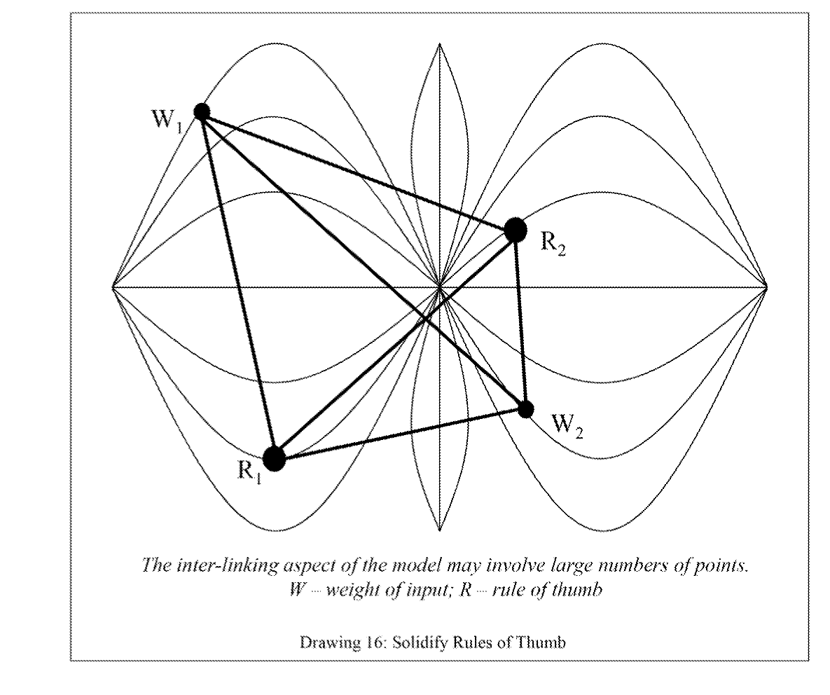

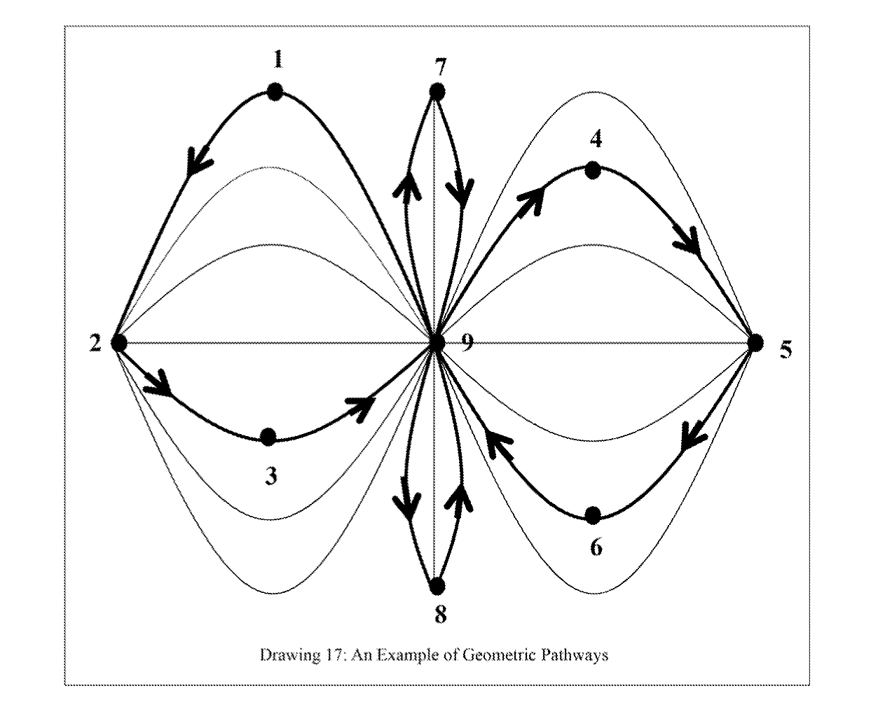

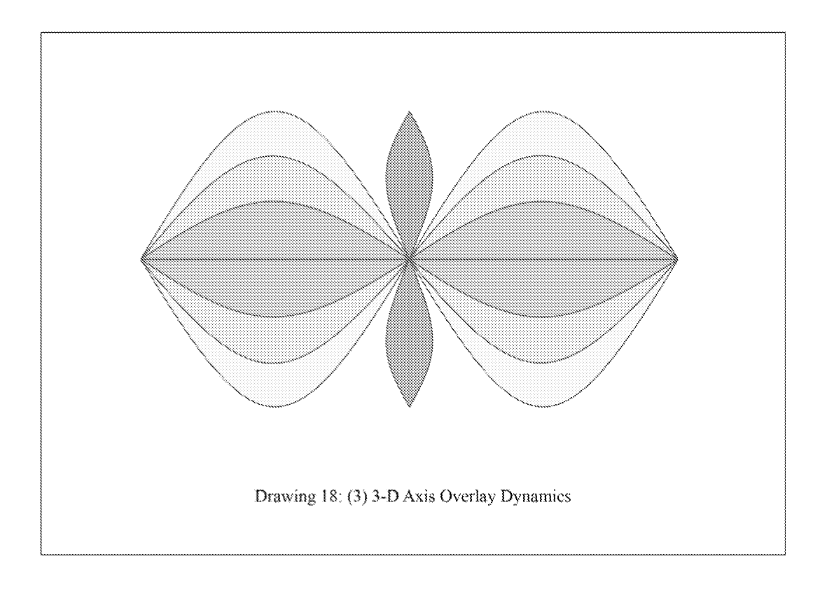

### SEARCHES

U.S. Patent Documents

| | | |
|---|---|---|
| 7,526,455 | Apr. 28, 2009 | Benson, et al. |
| 7,440,931 | Oct. 21, 2008 | Suzuki |
| 7,376,576 | May 20, 2008 | Dimitruk, et al. |
| 7,370,023 | May 6, 2008 | Forsythe, et al. |
| 7,330,841 | Feb. 12, 2008 | Cochran, et al. |
| 7,155,423 | Dec. 26, 2006 | Josephson, et al. |
| 7,117,161 | Oct. 3, 2006 | Bruce |
| 7,110,990 | Sep. 19, 2006 | Hoffman |
| 6,631,362 | Oct. 7, 2003 | Ullman, et al. |
| 6,102,958 | Aug. 15, 2000 | Meystel, et al. |
| 5,870,730 | Feb. 9, 1999 | Furuya, et al. |

### OTHER REFERENCES

Buss, D. (2000). The dangerous passion: Why jealousy is as necessary as love and sex. New York, N.Y.: The Free Press.

Byrnes, J. (1998). The nature and development of decision making: A self-regulation model. Mahwah, N.J.: Lawrence Erlbaum Associates.

Doi, T. (1981). The anatomy of dependency: The key analysis of Japanese behavior. Tokyo, Japan: Kodansha International.

Ennis, Ralph (2004). “A Theoretical Model for Research in Intercultural Decision Making”, Intercultural Communication Studies, Volume XIII, pp 113-124.

Fishburn, P. C. (1970). Utility theory for decision making. New York: John Wiley and Sons. Hart, S. and Carrington, H. (2002) “Jealousy in 6 month old infants”, Infancy, Volume 3, pp 395-402.

Kulich, S., Ennis, R. & Rhey, B. (2001). Cross-cultural dimensions of decision-making motives: Analysis in a Chinese framework with applications to business in China. Paper presented at The American Association of Behavioral & Social Sciences, Las Vegas, Nev., 2001.

Kuula, M. & Salminen, P. (1996). Prospect theory and mood. In P. Walden, M. Brännback, B. Back & H. Vanharanta (Eds.), The art and science of decision-making in honour of Christen Carlsson (pp. 127-137). Painosalama Oy, Åbo: Åbo Akademi University Press.

Lutz, C. (1983). Parental goals, ethnopsychology, and the development of emotional meaning. Ethos, 11, 246-262.

Maruyama, M. (1987). Communication between mindscape types. In J. VanGigch, (Ed.), Decision making about decision making: Metamodels and metasystems (pp. 79-97). Cambridge, Mass.: Abacus Press.

Mehrabian, A. (1995). Framework for a comprehensive description and measurement of emotional states. Genetic, Social, and General Psychology Monographs, 12 (3), 339-361.

Minsky, M. (2007). “The Discover Interview”, Discover, Volume 1, pp.14-18.

Poulson, C. (2000). “Shame: The Master Emotion?” University of Tasmania, School of Management Working Papers Series.

Tsien, Joe Z. “The Memory Code”, Scientific America, July 2007, pp. 52-59

Tversky, A. & Kahneman P. (1974). Judgment under uncertainty: Heuristics and biases. Science. 185, 1124-1131.

Wierzbicka, A. (1992). Semantics, culture, and cognition: Universal human concepts in culture-specific configurations. Oxford, England: Oxford University Press.

Wittgenstein, L. (1958). Philosophical investigations (2^{nd} ed.). (G. E. M. Anscombe, Trans.). Malden, M A: Blackwell Publishers. (Original work published 1953.)

Zaltman, G. (1997). Rethinking market research: Putting people back in. Journal of Marketing Research, Volume 34, pp 424-437.

Zaltman, G. (2000). Consumer researchers: Take a hike! Journal of Consumer Research, Volume 26, pp 423-428.

### SUMMARY OF THE INVENTION

The objective of this invention is to provide a means for mapping human decisions that is applicable across cultures differences. This invention provides a descriptive, prescriptive and predictive means of mapping decisions.

The Thought Dynamo Decision Mapping Model (TDD Model—see drawings 1 and 2) includes three overlapping 3-D grids that represent thought from the perspectives of intellect, emotions and imagined outcomes. The continuums of the logic of intellect are power-powerless, good-evil and accuracy-intuitive. The logic of emotion has three continuums: trust-fear, honor-shame, freedom-bonding. And the imagined outcomes continuums are thriving-surviving, desired identity-undesired identity, and meaningful-meaningless. The intersection of each grid forms a central tendency. For the logic of intellect the central tendency is space; for the logic of emotion the central tendency is jealousy; and the central tendency of imagined outcomes is creative harmony. Thus the overlap of all three grids forms a central tendency of thought and decisions to seek a creative harmony of jealous space.

A five step process of decision is posited: plot, associate, adjust, solidify and employ. Connectivity between thoughts and decision is apparent. Thoughts are required to make decisions and decisions are made within thinking. The dynamics of thought and decision are geometrically mapped (see drawings 14-18) by assigning weights to inputs, strength to associations, dynamically accounting for adjustments and solidifications over time and projecting rules of thumb in decision making onto (3) 3-D axes.

This model of thought and decision involves emotionality across cultural differences. The significant obstacle of diverse emotionality in positing a culture-general model of thought and decision is addressed by examining the Japanese emotion of “amae”.

The TDD Mapping Model can be used to shape research agenda. The research outcomes can be descriptive, predictive and prescriptive in nature.

### BACKGROUND OF THE INVENTION

The invented model will be referred to as the Thought Dynamo Decision Mapping Model (TDD Model). Various decision models have influenced the construction of the thought and decision model within this invention. Aspects of the Expected Utility Model, Prospect Model, Self-Regulation Model, and Reciprocal Causal Model are found within the TDD model.

The Expected Utility Theory (Fishburn, 1970) focuses on what action should be taken in a particular situation—what is the best choice. That determination of “should” or “best” is based firmly upon rationally exploring relevant data and options with some anticipation of an expected (imagined) outcome. Prospect theory (Tversky and Kahneman, 1974) addresses heuristics principles, rules of thumb which people employ to shorten the decision process. These rules of thumb can cause decision bias as well. The influence of a person's emotionality within prospect theory has been explored by Kuula and Salminen (1996). Byrnes (1988) put forth a self-regulation model of decision making. This model suggests people make decisions as an adaptive process in order to attain their own goals. At every juncture where a goal is blocked, people adapt (self-regulate) their decisions in order to attain their goals.

Reciprocal causal models are based on the idea that feedback from decisions impacts the basic harmony of a system and that diversity, not homogeneity, provides more harmony (Maruyama, 1987).

A consideration regarding decision models is the concept of a super-logic premise. This premise suggests that across cultures there is only one right way to logic, all other ways are inferior to super-logic. Maruyama (1987) critiques super-logic and posits that the theory of super-logic is “tautological rather than logical” (p.87).

The TDD model will employ aspects of the above theories while formulating a model that has descriptive, predictive and prescriptive value. This model posits a culture-general construct and thus implicitly accounting for logics across cultures.

In order to establish a geometric model of thought and decision, three types of space must be delineated—physical space, neural space and interpretative space.

Physical space is that space perceived by the mind to be external to the human mind but containing all else including neural space within the brain. Physical space can be perceived through sensory input by the mind. This interconnectivity of physical and mental space allows for the philosophical dialogue of a possible real-illusion paradoxical relationship.

Neural space is primarily within the brain. MRI brain research employs mapping techniques to identify areas of the brain that are engaged during specific mental activities. Those mental activities imply an interpretative space.

Interpretative space allows sensory input to be mapped and continuously processed (with varying weights) within a nature-culture schema that can be modeled on (3) 3-D overlapping axes. It is primarily interpretative space that this paper will address.

The creator of the smart mouse, Tsien (2007), within the fields of pharmacology and biomedical engineering, has suggested a means for mapping sensory input onto an interpretative space within mice. By inference, similar axes of interpretative space can be conceptualized for humans. The key would be to identify the axes that are most viable for human thought. It is those axes that are posited later in this paper.

“Software translated the data from an individual mouse into a 3-D plot that represented the activity of the full ensemble of recorded neurons when the animal was at rest and undergoing startling events. Such plots enabled researchers to “read” what was happening to an animal simply by watching the recorded signal move within that 3-D space.” (Tsien, 2007, p. 56)

“Remus Osan—another postdoctoral fellow—and I analyzed the recordings using powerful pattern-recognition methods, especially multiple discriminant analysis, or MDA. This mathematical method collapses what would otherwise be a problem with a large number of dimensions (for instance, the activities of 260 neurons before and after an event, which would make 520 dimensions) into a graphical space with only three dimensions. Sadly for classically trained biologists, the axes no longer correspond to any tangible measure of neuronal activity, but they do map out a mathematical subspace capable of discriminating distinct patterns generated by different events.” (Tsien, 2007, p. 55)

In establishing a methodology for mapping neuron activity and memory within mice onto a 3-dimensional graphic, Tsien (2007) has suggested, by inference, the possibility of mapping human thought onto a 3-D interpretative grid. The TDD mapping model invention will set forth a 3-D interpretative model for mapping ‘rules of thumbs’ for thought and decision within humans.

Space is seen as a panhuman intellectual construct that is useful for examining thought and decisions across cultures. The philosopher Wittgenstein (1958) referred to the “spatial and temporal phenomenon of language” (p. 47). Since all language systems arc purported to contain a spatial quality, it can be reasoned that spatial constructs with movements across time is an embedded panhuman thought platform.

### BRIEF DESCRIPTION OF THE DRAWINGS

The drawings, referred to in the detailed description, illustrate the invention and along with the detailed description serve as an explanation of the invention.

Drawing 1 Overview of Thought Dynamo Decision Model,

Drawing 2 Three Thought Dynamo Axes

Drawing 3 Eight Quadrants of Logic of Intellect

Drawing 4 Eight Quadrants of Logic of Emotion

Drawing 5 Eight Quadrants for Imagined Outcomes

Drawing 6 Overlapping Axes of the Thought Dynamo

Drawing 7 Trust-Fear Continuum Expanded

Drawing 8 An Example of Movements within the Thought Dynamo

Drawing 9 Five Types of Decisions

Drawing 10 Various Questions for Abstract Rules of Thumb

Drawing 11 Paradoxes

Drawing 12 Summary of Rules of Thumb

Drawing 13 Summary of Decisions

Drawing 14 Plot Input

Drawing 15 Associate and Adjust

Drawing 16 Solidify Rules of Thumb

Drawing 17 An Example of Geometric Pathways

Drawing 18 (3) 3-D Overlapping Dynamics

### DETAILED DESCRIPTION OF THE INVENTION

At the center of the Thought Dynamo Decision (TDD) mapping model (see drawing 1) is an ongoing process, a thought dynamo, that can be modeled as three overlapping 3-d axis involving the logic of intellect, logic of emotions and imagined outcomes. At all aspects of this model of thought and decision, this thought dynamo is in action. The thought dynamo will be further examined in the next section.

Decisions, generated by the thought dynamo, can be classified into five broad categories: plot, associate, adjust, solidify, and employ. Below is a brief description of these five types of decisions. (These decisions will be examined in more detail within the section “Decision Dynamics”.)

1. Plot Decisions: Decisions arc made to plot various sensory inputs that come from goal seeking or from non-solicited input or from feedback from outcomes of previous decisions or from thoughts as inputs. Each plotted point is assigned a location and weight. For instance, if a dog walks by a crying baby in a stroller and stops to sniff, the mind will plot many inputs. [Plotting that is essentially feedback from external sources on previous decisions is significantly different from other input in that it links the person with the input. There is an implied or established “I causal” relationship.]

2. Association Decisions: The decision to associate (link) input with similar input is also a decision to assign some strength to that association. This decision is often performed with little awareness. For instance, the dog will likely be associated with other inputs of dogs.

3. Adjustment Decisions: New input dynamically impacts previous input. Thus with each new plot (location and weight) and association (link and strength) comes a readjustment (negligible or significant) of all relevant inputs. If the sniffing dog, from the above example, is a German shepherd, the strength of association may be extremely strong or substantially weak depending on previous experiences with this type of dog. The initially assigned strength will then be adjusted to accommodate the specific context in which the dog is sniffing a helpless baby.

4. Solidification Decisions: As time progresses, decisions are solidified with various degrees of congruence, contradiction, disillusionment and paradox. This solidification forms various types of rules of thumb. If the strength of association of a German shepherd sniffing a baby was weak, as we continued walking past this scene and replayed the scene in our memories, we might solidify our previous association and adjustment decisions as we reinterpreted this memory.

5. Employment Decisions: In the course of living, we make many behavioral decisions. In so doing we employ previously plotted input that was assigned strength of association, adjusted and then solidified using the thought dynamo of logic of intellect, logic of emotions and imagined outcomes. This employment results in verbal and non-verbal actions that impact outwardly.

Each of these decisions are linked to form a very complex system of thought and behavior decision making across various aspects of time, notably a present, past and future. Plotting sensory input that is “beyond me”, i.e. external to my thoughts, and that arrives in a present is influenced by our culturally impacted perceptions and by the awareness level of our consciousnesses. At any given moment we arc aware of various aspects of input while other aspects “blow through” our mental awareness. That awareness can be culturally honed to “look for” various types of input while ignoring other inputs.

There are three fundamental limitations of the model. First, the model seeks to describe the “software” of thought—not the “hardware” of the brain and yet not contradicting the hardware limitations.

Second, this model does not easily deal with false data and with irony. Straightforward input is more easily handled. However, as more sophisticated rules of thumb are solidified, false and ironical inputs arc more accurately addressed.

And third, the model enfolds onto itself from all points into the paradox of “self defining self”. The connectivity between thought and decision is apparent and circular. Thoughts are required to make decisions and decisions are made within thinking.

The next two major sections will examine the thought dynamo and decision dynamics. Afterwards the topic of mapping will be addressed along with an example from the Japanese cognitive construct of “amae” (Doi, 1981). This example will support the utility of the TDD model across cultures.

Thought Dynamo

The thought dynamo (see drawing 2) is at the center of this model. It drives and is driven by the five types of decisions previously discussed. The model posits three intersecting axes: logic of intellect, logic of emotion and imagined outcomes (Ennis, 2004; Kulich, et al., 2001). These intersecting axes can be conceptualized to account for such abstract notions as beauty, love and amae.

Logic of Intellect

The logic of intellect in this model has three axes: power axis, moral axis, and certainty axis (see drawing 3; the boxes are used to clarify the continuous eight geometric quadrants). The power axis is a continuum from powerful to powerless. The moral axis is a continuum from good to evil. The certainty axis is a continuum from accuracy to intuitive. And the central construct of the logic of intellect is space. Each of the specifics of the axes is defined by every culture. However, the model posits that all cultural logics involve these three axes of continua.

Logic of Emotions

Similarly, the logic of emotion (see drawing 4) is posited to involve three axes: relational, hierarchal and liberty. The relational axis is a continuum from trust to fear. The hierarchal axis is a continuum from honor to shame. The liberty axis is a continuum from freedom to bonding. And the central construct of the logic of emotion is jealousy. [Jealous is thus posited as the central tendency of human emotion in contradiction to Poulson's (2000) suggestion that shame is the master emotion. Furthermore, jealousy is a strong emotion “critical to the success and proliferation of our ancestors” (Buss, 2000). And a jealous reaction has been observed in six-month-old infants (Hart and Carrington, 2002)]

These few emotional constructs can account for many emotional states. Each of the thirty-four emotions posited in the PAD (Pleasure-Arousal-Dominance) Emotional-State Model (Mehrabian, 1995) can be conceptualized as blended from the three continuums of the logic of emotion.

Imagined Outcomes

The construct of imagined outcomes is posited to involve three axes: adaptation, meanings and identity. The central construct of imagined outcomes is posited as creative harmony (see drawing 5).

As a present process, the logic of intellect and emotions both have two other time elements embedded in them. The past has been processed and stored through these axes. And a second time element can be conceptualized as imagined outcomes (anticipated results in the future). While acknowledging that the duration of time implicit in imagination is culture-specific, this model positions imagination into a forward spatial non-presence as a culture-general construct. A future imagined outcome emphasizes the possibility of decisions modifying a present assessment of reality. These imagined outcomes also create the possibility of re-interpreting the past with present thoughts and decisions.

Overlapping Dynamics

Drawing 6 depicts the intersecting dynamic of the three sets of axes. Good, honor and meaningful interact on a continuum with evil, shame and meaninglessness. Powerful, freedom and thriving interact of a continuum with powerless, bonding and survival. And accuracy, trust and desired identity interact on a continuum with intuitive, fear and undesired identity. The central construct of these intersecting axes is creative harmonious, jealous space. The logic of emotion, logic of intellect and imagined outcomes are therefore conceptualized to interact with and influence each other. The relative weights of these factors account for the differences in individual and cultural decision making preferences. It should also be noted that if these axes ‘twist’, that twisting can account for various aspects of mental health dysfunction.

Expanded Continuums

Each of the nine continuums can be expanded to show the complexity of thought and decision. Drawing 7 expands the trust-fear continuum. All other continuum can be similarly expanded. Below is an explanation of this expansion by use of internal “I” thoughts.

Unexamined:

I trust (someone, something) without significantly examining a variety of circumstances.

Reasoned:

I have reasoned with logic of intellect and emotion and imagined outcomes and have concluded that I will trust (someone, something) in general.

Qualified:

I will trust (someone, something) under specific circumstances only.

Numbness:

I am ambivalent (numb) regarding trust.

Disillusionment:

I am disillusioned. Further interpretation of cause and effect has led me to conclude that my original weighted position was inaccurate thus creating cognitive dissonance. I may live with this disillusionment or “flip” it to the other side of the axis (e.g. disillusioned reasoned trust may become reasoned fear) or in extreme cases this may lead to sheering of axes.

Paradox:

I am living with the paradox of trusting what I fear and fearing what I trust. I may passionately embrace this paradox or distain it or be numb (disconnected) or be at peace (and connected) with this paradox.

Again, each of the nine continuums can be expanded in similar fashion.

An Example of Movements within the Thought Dynamo

Below is a description of various possible movements within the thought dynamo (see drawing 8). These movements account for the decision to change one's mind as more input is gathered or more time to process has occurred.

1. One might begin his/her journey of trusting some person from a location of “unexamined trust” (see location 2 on drawing 8).

2. If contrary input (often a non-comic pain type of input such as being lied to) outweighs this “unexamined trust”, then a “point of disillusionment” (location 2) might occur.

3. This might move to a point of “disillusioned qualified trust” (location 3) possibly enhanced by a sense of non-comic pleasure (e.g. the pleasure of regaining control in the relationship by moving through disillusionment).

4. “Qualified fear”(location 4) might follow, possibly enhanced by a sense of comic pleasure (e.g. a comic pleasure of feeling that the other was beaten at his/her own game).

5. If sufficient input occurred (often non-comic pain) that outweighed this “qualified fear”, then a second “point of disillusionment” (location 5) might occur. (This pain might include a personal sense of shame for not forgiving the person for his/her previous breach of trust.)

6. “Disillusioned reasoned fear” (location 6) might follow and be enhanced by non-comic pleasure of feeling superior to one's previous conclusions.

7. With sufficient input and/or reason, a “passionate paradoxical” (location 7) state might occur. That is, “I see and I passionately embrace” that this particular person can be trusted and feared simultaneously.

8. As time proceeded and the impact of this paradox is absorbed into the decision process, he/she might “distain this paradox”(location 8) as a complexity that doesn't facilitate decision goal seeks.

9. If enough pain (comic or non-comic) occurs, then a sense of unconnected numbness might set in: “I see the paradox and I'm ambivalent” (location 9). This unconnected numbness may be wearisome as the play of comic and non-comic pain and pleasure continues.

10. If enough pleasure occurs, then a sense of connected peace within this paradox might settle in (a sufficiently weighted point at location 9).

Decision Dynamics

This section will expand the five types of decisions. Each decision type (see drawing 9) is regulated through the thought dynamo: logic of intellect, logic of emotion and imagined outcomes.

Plot

Three prescreens occur before input is plotted. First, the input is screened for recognition. Most sensory inputs available to the mind simply “blow through”. They are not plotted.

Second, sensory input is prescreened as painful or pleasurable. The immediate basis for such pre-classifications seems to be energy tolerance limits. For instance, if a hot cup of coffee is touched, this prescreen will impact the plotting of this input.

A third prescreening seems to revolve around the notion of comic and non-comic input. This is a more culturally constructed notion that will include the notions of irony, deception and laughter. These notions are really complex and yet input must first go through this prescreen before being plotted. The rules of the comic—non-comic continuum arc embedded within the (3) 3-D axes (see drawing 2) and derived over time by the individual and culture.

Pain-pleasure and comic-non-comic continuums serve to modify human thoughts and decisions. For instance, the dog and baby input might be prescreened as comic pleasure—the pleasure of seeing a baby's face in response to the dog's sniffing. Similarly, that same input might be classified by another as a non-comic pleasure—the pleasure of harmony between babies and dogs without any sense of threat. However, this same input could be classified as non-comic pain since the baby was crying and the dog might enhance the threat to the child. And finally a comic pain might result from seeing the pain of a crying baby shift to a response of a bewildered crying tone and a bewildered dog's face as he sniffs. These options are complicated and form a vast array of possibilities within any given situation.

After these prescreens, the sensory input is plotted for location and weight onto the (3) 3-D axes of logic of intellect, logic of emotion and imagined outcomes. Initial weight of input is directly proportional to emotional and rational intensity of the event.

Note that words can be plotted in this scheme. All words are spatial at some level of abstraction. All images, music, tastes, smells and touches are also fundamentally spatial—involve particles and waves within physical space. And thus thoughts can be viewed as inputs and are similarly plotted.

Associate

Each input is associated with similar inputs. All input enters through these three center constructs and is disseminated by the strength of attraction from previous inputs organized into rules of thumb. This strength of associations is established through the weights, location and numbers of rules of thumb that have similar spatial/ jealousy/ harmony characteristics.

Strength of association is an attraction factored by previous rules of thumb. Thus, rules of thumb are “seeking” reinforcing input in order to maintain and re-enforce their weight. Lack of new input causes the strength of the rule to fade at some rate. Contradictory input also lessens the weight of the rule.

Adjust

Almost simultaneously, these input weights are modified (through strength of association) by previously plotted inputs and established rules of thumb. New input impacts previous input and previous input impacts new input, thus plotted input must be continuously adjusted to various degrees.

Weights of various types of rules of thumb are directly proportional to number, weights and location of supporting inputs for each rule.

Solidify

Solidifying rules of thumb in memories (supported by inputs) is a rehashing of the past in a present. The brain does the hard storage of memories and the mind somehow activates these memories for a “present” rehashing (at various levels of consciousness) of thoughts, decisions and outcomes. This solidification form and reshape rules of thumb. Within the thought dynamo, rules of thumb are activated.

The TDD mapping model will posit four types of rules of thumb 9 see drawing 9). The first are innate rules of thumb. These are posited as hardwired within human minds across cultures and time periods. These rules are the (3) sets of 3-D axes: logic of intellect, logic of emotions and imagined outcomes. These 9 continuums with 3 central tendencies are deemed innate (i.e. hardwired into the mind); they are apparent from early childhood and form the basis of all other types of rules of thumb.

A second type of rules of thumb involves metaphors. In order to efficiently process large amounts of input, the mind, over time, forms image and verbal metaphors. Tastes, touches and smells are often associated with various words and images. [“It smells like” is a verbal metaphor that is often linked with some image.] Each image and verbal metaphor can be located within the (3) 3-D axes. This simplification speeds the mind to conclusions. For instance, we may have visual and/or verbal metaphor for an older male or female. This type of person may fall within the “father” or “mother” verbal metaphor with many associated thoughts and emotions and imagined outcomes. Similarly an image is usually attached to this metaphor. Thus two people may use the same word metaphor while their image metaphor may be substantially different based upon their previously gathers input concerning “father” or “mother” (Zaltman, 1997, 2000). Verbal and image metaphors constitute a significant agenda for field research.

Thirdly, situational rules of thumb help us negotiate various circumstances with many real-time factors interacting simultaneously. Situational rules thumb are logical steps of actions when presented with various types of situations. Previously established, these situational rules seamlessly guide much of life. The previously mentioned dog and baby situation is an example. A verbal rule of thumb for many people may be “a baby is to be protected”. As the situation unfolds all input is focused to ascertain one question “Is this precious baby in any threat?” The rule thus implies “I will protect this precious baby if threaten by this dog.”

Abstract rules of thumb are a fourth type. An abstraction such as “innocence is precious” is a complex conclusion that can be applied in many situations. These abstractions help mold long-term convictions within people as they negotiate the complexity of life. However, these abstractions, if not thoroughly grounded by innate, verbal and image metaphorical and situational rules of thumb, may simply serve as conceptualization but not as rules of thumb that will govern employment decisions.

Abstract rules of thumb are a complex combination of innate, metaphorical and situational rules of thumb. Abstract rules of thumb are higher order rules that shape decision making across complex issues (for instance, the innocence of children is precious or life is valuable). Some people form few abstract rules that they can articulate, while others develop many highly conceptualized abstractions.

Six general abstract questions of reality can account for many abstract rules of thumb (see drawing 10). Each of these can be mapped onto (3) 3-d continuums. These abstract rules of thumb form basic convictions/worldview beliefs of determination that can be employed through making decisions in non-stressed and stressed situations. [Obviously many subsequent questions follow from these six categories—and the categories can be restructured as well.]

Goal Seek: Congruence, Contradiction, Disillusionment, Paradox

All rules of thumb have goal seeks. That is, these rules seek to achieve a congruence of thought, minimize contradictions, avoid disillusionment and come to a connected peace with paradoxes by negotiating various levels of comic and non-comic pain-pleasure which form stresses.

The primary goal seek of all rules of thumb is a sense of congruence. The mind seeks to be integrated in manageable degrees. Total congruence does not occur, yet a desire for making consistent sense of the world is a continual goal seek.

Within this goal of congruence, the mind seeks to identify contradictions. These contradictions arc dealt with by readjusting pervious rules and forming new rules. If no suitable rule is readily available, then a sense of disillusionment is established. This disillusionment may be brief and hardly recognizable or deeply painful and lingering over long periods of time.

If congruence seems impossible and contradiction undeniable, disillusionment may help establish a category of paradox. The establishment of a paradox is a means of resolving contradiction through disillusionment and bringing a new sense of “consistency”—a paradoxical consistency.

If proposition “A” and “B” both appear true when considered separately and in conflict when considered jointly, then a paradox has occurred. For instance, the free will of humankind and the sovereignty of God have seemed reasonably true for many when viewed separately; viewed together they form a paradox.

In this model of decision, paradox is mapped on a vertical axis (see drawing 11 ). This movement to paradox can occur rapidly. What gives the “ah ha” moment of paradox? Sometimes reason and sometimes a more intuitive process involving tapping into the innate category of paradox that can be nurtured over time and with reason. This paradox may be acknowledged with an emotional sense of unconnected numbness (ambivalence) or a sense of connected peace.

See drawing 12 for a summary of the rules of thumb.

Employ

All thought decisions (plot, associate, adjust and solidify) are internal. All employment decisions are conceptualized with external consequences of some form. Externally oriented decisions are made by employing the various types of rules of thumb (innate, metaphorical, situational and abstract). Thus speaking out loud, non-verbal expressions and physical movements are viewed as external, i.e. they have direct external interface with the environment.

The thought dynamo is in play as employment decisions are made. That dynamo contains the rules of thumb which make most decisions relatively easy (when compared with the effort that would be necessary to process all relevant data.)

The goals of employment are implicit within imagined outcomes. We imagine outcomes (with varying degrees of lucidity and accuracy) prior to making a decision. Those imaginations of adaptation (thriving-surviving), identity (desired-undesired), and meaning (meaningful-meaningless) are the end goals as we make employment decisions.

After these decisions are made, feedback, usually immediate and often long-term, will be gathered. This feedback is then new input to be plotted, associated, and adjusted and solidified as the future employment of rules are made in real-time.

Under stress, the mind will default to previous rules of thumb rather than attempting to take the time to reason new rules or validate old rules with new input. Later the rules of thumb employed under stress will be associated, adjusted and solidified. There is often a dissonance between non-stressed and stress rules of thumb. (Note: Stress is defined as fear of loss—thus plotted primarily onto the trust-fear continuum.)

All employment decisions contain a logic of yes, no, suspend or create. For instance, “Yes I decide option A over B.” “No, I decide not to choose option C.” “I decide to suspend this decision at this time.” “I decided to create new alternatives for this decision set.” These four options apply to the imagined outcomes of adaptation, identity and meaning.

Summary of Decisions

In drawing 13 each of the five types of decisions are summarized. This flow coupled with the thought dynamo can generate the complexity of thought and decision.

Mapping: Geometrical Representation

Drawings 14 through 18 geometrically describe the mapping of input and rules of thumb, within the TDD model.

In drawing 14 an input has been assigned a location and a weight on the (3) 3-D axes.

In drawing 15 an association with previous input has been established and the strength of that association has been assigned. A subsequent adjustment movement is made as these two inputs impact each other.

If this association exceeds some strength, then plotted input can ‘jump’ the sine rails. Also in time the strength of association can weaken or strengthen.

In drawing 16 weighted inputs are impacted by rules of thumb and vice versa. These rules of thumb have been formed through groupings of weights—solidification.

An example of pathways for input and rules of thumb is given in drawing 17. This pathway is one of many that can be conceptualized.

As employment decisions are made, these decisions become new “thought” inputs and the cycle of plotting, association, adjusting solidifying and employing continues and are mapped accordingly.

It should be noted that all these plots, associations, adjustments, solidifications and employment decisions occur with the (3) 3-D aspect of this model (drawing 18).

Computer Modeling

The geometrical nature of the model lends itself to mathematical equations and computer modeling. If input can be plotted, associated, and adjusted and the dynamics of rules of thumb calculated, then decisions can be predicted (or reasonably formulated) using computer modeling.

Rules for Optimization

This section will suggest logical rules for optimization of decision making under multiple weighted points over varying periods of time. The primary assumption in optimization of decision making is the selection of one or more points to be optimized within the weighted spherical modeling of decision making. In the case of a singular point, optimization is geometrically apparent—consistency in decision making to achieve congruence that increases or maintains the weight of a particular locus point. For instance, if a particular desired identity is a singular point, then all decision making can be focused on achieving that optimal identity. However, most decision making is far more complicated. Multiple points for optimization are the norm, not the exception. Achieving a desired identity at the cost of good-evil or fear-trust is not optimal decision making for most contexts.

In order to model the optimization of multiple points with varying intensities, the concept of stress lines between points must be managed through decision making. These lines can be lines of congruence, contradiction, disillusionment, or paradox. In other words, these four goal-seeks of decision are key to the process of optimization of multiple points. Within the spherical model, proximity of weighted points can be managed for optimization by the reduction of intensity of stress line between two or more points. The intensity of a stress line is directly proportional to: 1) the weight of each locus point, 2) the distance between loci (the greater the distance the greater the stress up to some point and then a process of detachment begins), 3) the distance from the central construct of the interrelated axes to the various points, and 4) the stress of indecision over time. The goal in optimization is to manage stress lines in a way that forms a paradoxical central points (not a congruent point, a contradictory point, or a disillusionment point). This paradoxical central locus point is a fuzzy point at or near the central construct of the interrelated axes. The greater the distance from the central construct of the interrelated axes, the more likelihood that the goal of long-term optimization will degenerate into congruence for short-term optimization or contradiction (failure to achieve an optimal decision) or disillusionment (a decision to abort an optimization process).

Thus, the fuzzy optimal decision of multiple loci in multiple contexts over a long-term can be modeled as a paradoxical solution in the vicinity of the central construct of the interrelated axes. The optimization will remain fuzzy in that it is viewed as a ‘fluid particle’ solution rather than a solid plotted point within the weighted sphere.

Mapping the Japanese Construct ‘Amae’

In order to establish the utility of the TDD model across cultures, the Japanese construct of ‘amae’ will be considered. Below is a means of mapping ‘amae’ onto the (3) 3-D axes of the thought dynamo. This example is chosen to address this question: Can the TDD model reasonable address intellectual and emotional reasoning and imagination across cultural boundaries? The description below provides a non-specific path to that mapping. A specific map can be formed by gathering weighted data from the Japanese population.

Wierzbicka (1993) does not perceive understanding emotions as an easy endeavor, but rather one that requires difficult translation. She stated, “I maintain, however, that no matter how ‘unique’ and ‘untranslatable’ an emotion term is, it can be translated on the level of semantic explication in a natural semantic metalanguage and that explications of this kind make possible that ‘translation of emotional worlds’ (Lutz 1985a) which seems otherwise impossible to achieve” (p. 135). I view the translation of complex culturally constructed emotions as a crucial issue. The TDD model must be able to aid in emotional translation in order to be considered a culture-general model of thought and decision.

Japanese psychiatrist Takeo Doi (1981) described in detail the dynamics of amae in the Japanese culture stating, “The Japanese term amae refers, initially, to the feelings that all normal infants at the breast harbor toward the mother—dependence, the desire to be passively loved, unwillingness to be separated from the warm mother-child circle and cast into a world of objective ‘reality’ ” (p. 7). He went on to say, “ . . . all the many Japanese words dealing with human relations reflect some aspect of the amae mentality. This does not mean, of course, that the average man is clearly aware of amae as the central emotion in ninjo (human feeling)” (p. 33). Furthermore, he compared the Japanese with Westerners in stating, “Scholars have put forward many different theories concerning the ways of thinking of the Japanese, but most agree in the long run that, compared with thought in the West, it is not logical but intuitive” (p.76). Doi proposed outsiders struggle with the amae construct. He stated, “ . . . to persons on the outside who do not appreciate amae, the conformity imposed by the world of amae is intolerable, so that it seems exclusivist and private, or even egocentric” (p. 77).

The TDD mapping model can be used to translate the Japanese construct of amae. This meta-language construct is not intended to fulfill the richness of the Japanese construct but rather to approximate its construction in such a way that translates amae into the meta-language of the TDD model. The amae construct is the dependency implied in leaning on the goodwill of benevolent other(s). it requires trust in other(s). It implies the fear of being betrayed by others. It requires the bonding of dependency. It yields the freedom of dependency. It requires the honor of submitting to another's will. It forbids the shame of betraying another. It requires the management of a privileged and thereby jealous relationship between people. It yields the power of being provided for. It requires the powerlessness of receiving. It requires intuition to negotiate relationships. It assumes the accurate interpretation of amae as a social construct. It requires an acknowledgement of good in one's in-group. It hold that evil is betrayal of one's in-group. It requires the negotiation of space between two or more people. It requires the proper networking of relationships for both surviving and thriving. It requires a desired identity of being fundamentally a self that is dependent. It views the absence of a dependent relationship as an undesired identity. It views the parent-child relationship as the fundamental meaningful relationship. It views the absence of amae as fundamentally a meaningless existence. It requires both persons in the relationship maintain and creatively enhance harmony within the relationship.

The invention claims are:

1. This mapping process can be used to map human decisions (across the range of cultural differences) onto three overlapping three dimensional grids.

2. This mapping process can be used to describe decisions.

3. This mapping process can be used to prescribe (i.e. optimize) decisions.

4. This mapping process can be used to help predict decisions.
